(19) United States
(12) Patent Application Publication
(10) Pub. No.: US 2009/0225498 A1
(43) Pub. Date: Sep. 10, 2009

(54) Asymmetric hybrid capacitor using metal oxide materials for positive and negative electrodes

(75) Inventors: Eun Sung Lee, Seoul (KR); Kyun Young Ahn, Gyeonggi-do (KR); Kwang Bum Kim, Seoul (KR); Kyung Wan Nam, Seoul (KR); Sang Bok Ma, Seoul (KR); Won Sub Yoon, Seoul (KR)

Correspondence Address: EDWARDS ANGELL PALMER & DODGE LLP, P.O. BOX 55874, BOSTON, MA, 02205, US

(73) Assignees: Hyundai motor Company, Seoul (KR); Industry-Academic Cooperation Foundation, Yonsei University, Seodaemun-gu (KR)

(21) Appl. No.: 12/228,730

(22) Filed: Aug. 15, 2008

(30) Foreign Application Priority Data
Mar. 6, 2008 (KR) 10-2008-0020966

(51) Int. Cl. H01G 9/00; H01G 9/15

(52) U.S. Cl. 361/523; 361/500

(57) ABSTRACT

The present invention provides an asymmetric hybrid capacitor, in which metal oxide containing lithium and capable of producing lithium ions by an electrochemical reaction and supplying the lithium ions in an electrolyte in the capacitor is used as a positive electrode active material, and metal oxide capable of accepting the lithium ions supplied through the electrolyte is used as a negative electrode active material, such that the lithium ions of the same participate in the electrochemical reactions at both electrodes. As a result, it is possible to minimize reduction in ionic conductivity during charge/discharge, compared with conventional asymmetric hybrid capacitors, in which metal oxide and a carbon material are used as electrode materials, respectively. Moreover, since metal oxide having high specific capacitance is used to form both electrodes, it is possible to maximize energy density and power density.

### CROSS-REFERENCE TO RELATED APPLICATION

This application claims under 35 U.S.C. §119(a) the benefit of Korean Patent Application No. 10-2008-0020966 filed Mar. 6, 2008, the entire contents of which are incorporated herein by reference.

### BACKGROUND

(a) Technical Field

The present invention relates to an asymmetric hybrid capacitor. More particularly, the present invention relates to an asymmetric hybrid capacitor, in which metal oxides are used as positive and negative electrode active materials.

(b) Background Art

Recent researches on energy storage materials have been focused on maximizing the capacitance of a capacitor having high power or improving power characteristics of a secondary battery having high capacity.

A secondary battery is a rechargeable battery, where the capacitor has a specific capacitance of at least 1,000 times greater than those of conventional capacitors, and is thus called a supercapacitor.

The conventional capacitors, in which a carbon material is used as an active material for both positive and negative electrodes, are widely used in the field where high output energy characteristics are required. However, the carbon material has a drawback that its capacitance is low and thus extensive researches have been conducted aiming at developing a pseudocapacitor, where a metal oxide having a relatively high capacity is used as an electrode active material, as an alternative for improving the capacitance characteristics of the conventional low-capacitance capacitors. Of them, manganese oxide such as MnO₂ or LiMn₂O₄, which is relatively inexpensive and environment-friendly, has drawn much attention as an electrode active material for the capacitor or a next-generation battery.

In a conventional pseudocapacitor, one electrode is formed of a metal oxide such as manganese oxide, and the other electrode is formed of a carbon material. In the metal oxide electrode, the energy is stored by an insertion/extraction reaction of lithium ions while it is stored in the carbon electrode by absorption/desorption of anions. The different ionic species participate in the respective electrochemical reactions of the metal oxide and carbon material, and thus the ions may be exhausted in the electrolyte, thereby reducing power density.

Moreover, the theoretic electric charge amount available per unit volume of the metal oxide is at least 10 times larger than that of the carbon material. Therefore, when the metal oxide and the carbon material are used to form the respective electrodes, it is necessary to use an excessive amount of a carbon material to match the charge amounts of both electrodes, which causes an increase in the overall volume of the capacitor and reduction in the overall energy density and power density.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides an asymmetric hybrid capacitor, the asymmetric hybrid capacitor comprising: a positive electrode active material composed of a metal oxide containing lithium and capable of producing lithium ions by an electrochemical reaction and supplying the lithium ions to an electrolyte in the capacitor; and a negative electrode active material composed of a metal oxide capable of accepting the lithium ions supplied through the electrolyte, such that the lithium ions of the same species move between the positive electrode active material and the negative electrode active material through the electrolyte to achieve charge/discharge.

In a preferred embodiment, the metal oxide of the positive electrode active material is one selected from the group consisting of LiMn₂O₄, LiMnO₂, LiCoO₂, LiNiO₂, LiFePO₄, and LiCoₓNi_{y}Mn_{z}O₂ (0<x,y,z<1).

In another preferred embodiment, the metal oxide of the negative electrode active material is one selected from the group consisting of MnO₂, V₂O₅, Ni(OH)₂, NiO, RuO₂, Fe₂O₃, TiO₂, Li₄Ti₅O₁₂, Co(OH)₂, and Co₃O₄.

In still another preferred embodiment, the positive electrode comprises 60 to 90 wt % of the metal oxide used as an active material, 5 to 30 wt % of a conductive material, and 3 to 15 wt % of a bonding material.

In yet another preferred embodiment, the negative electrode active material is a metal oxide/carbon composite material in which the metal oxide is coated on the surface of a carbon material, and the negative electrode comprises 60 to 90 wt % of the metal oxide/carbon composite material, 5 to 30 wt % of a conductive material, and 3 to 15 wt % of a bonding material.

In still yet another preferred embodiment, the carbon material is one selected from the group consisting of carbon powder, carbon black, acetylene black, ketjen black, activated carbon, carbon nanotubes (CNT), carbon nanofibers (CNF), carbon nanowires (CNW), and carbon nanohorns (CNH).

The asymmetric hybrid capacitors according to the present invention can minimize reduction in ionic conductivity during charge/discharge and maximize energy density and power density.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircrafts, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a graph showing first charge/discharge characteristics of an asymmetric hybrid capacitor using manganese oxide in accordance with a preferred embodiment of the present invention; and

FIG. 2 is a graph showing energy density vs. power density of the asymmetric hybrid capacitor of in accordance with the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particularly intended applications and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

The present invention provides an asymmetric hybrid capacitor, in which a metal oxide capable of supplying lithium ions through an electrolyte is used as a positive electrode active material, while a metal oxide capable of accepting the lithium ions supplied from the positive electrode active material through the electrolyte is used as a negative electrode active material.

Accordingly, since the lithium ions of the same species participate in the electrochemical reactions at both electrodes, it is possible to prevent the ionic species in the electrolyte of the capacitor from being exhausted and minimize reduction in ionic conductivity during charge/discharge, compared with conventional asymmetric hybrid capacitors in which metal oxide and a carbon material are used as electrode materials, respectively. Moreover, since a metal oxide having high specific capacitance is used to form both electrodes, it is possible to maximize energy density and power density.

The asymmetric hybrid capacitor in accordance with the present invention will be described in more detail below.

In the capacitor of the present invention, a metal oxide containing lithium and capable of producing lithium ions by an electrochemical reaction and supplying the same to the electrolyte in the capacitor is used as the positive electrode active material. The positive electrode active material may include one of selected from the group consisting of LiMn₂O₄, LiMnO₂, LiCoO₂, LiNiO₂, LiFePO₄, LiCoₓNi_{y}Mn_{z}O₂ (0<x,y,z<1) and a combination thereof. The positive electrode of the capacitor may include the metal oxide used as the active material, a conductive material, and a bonding material. Preferably, it comprises 60 to 90 wt % of the metal oxide, 5 to 30 wt % of the conductive material, and 3 to 15 wt % of the bonding material.

In this case, if the metal oxide is contained less than 60 wt % in the positive electrode, the reduced amount of the metal oxide may reduce the capacitance of the electrode. In contrast, if it exceeds 90 wt %, the amount of the conductive material is reduced and thus the conductivity may not be sufficient. Accordingly, it is preferable that the content of the metal oxide be in the range of 60 to 90 wt %.

The conductive material may include one selected from the group consisting of carbon nanotubes (CNT), ketjen black, acetylene black and a combination thereof. If the content of the conductive material exceeds 30 wt %, the conductivity is improved; however, the amount of the metal oxide is reduced relatively and thus the capacitance of the electrode may be reduced. Accordingly, it is preferable that the content of the conductive material be in the range of 5 to 30 wt %.

The bonding material may include one selected from the group consisting of polyvinylidene fluoride (PVDF), polytetrafluoroethylene (PTFE) and a combination thereof. When the content of the bonding material exceeds 15 wt %, the bonding force between electrode materials is increased, but it also results in increase in electrode resistance. Accordingly, it is preferable that the content of the bonding material be in the range of 3 to 15 wt %.

Meanwhile, a metal oxide capable of accepting the lithium ions supplied from the positive electrode active material through the electrolyte is used as the negative electrode active material. Preferably, a composite material in which the metal oxide is coated on the surface of a carbon material may be used as the negative electrode active material.

The carbon material may include one selected from the group consisting of carbon powder, carbon black, acetylene black, ketjen black, activated carbon, carbon nanotubes (CNT), carbon nanofibers (CNF), carbon nanowires (CNW), carbon nanohorns (CNH) and a combination thereof.

For example, the negative electrode active material may comprise a metal oxide/carbon composite material, in which a metal oxide capable of accepting lithium ions is coated on the surface of carbon nanotubes (CNT), and the metal oxide may be one selected from the group consisting of MnO₂, V₂O₅, Ni(OH)₂, NiO, RuO₂, Fe₂O₃, TiO₂, Li₄Ti₅O₁₂, Co(OH)₂, Co₃O₄ and a combination thereof.

Of them, Li₄Ti₅O₁₂ is metal oxide containing lithium and capable of accepting lithium ions. Since the lithium ions inserted into Li₄Ti₅O₁₂ is not extracted therefrom, it is impossible to use Li₄Ti₅O₁₂ as the positive electrode active material; however, since the lithium ions can be inserted into the Li₄Ti₅O₁₂, it is possible to use Li₄Ti₅O₁₂ as the negative electrode active material.

The negative electrode of the capacitor may include the metal oxide/carbon composite material used as the active material, a conductive material, and a bonding material. Preferably, it may comprise 60 to 90 wt % of the metal oxide/carbon composite material, 5 to 30 wt % of the conductive material, and 3 to 15 wt % of the bonding material.

If the metal oxide/carbon composite material is contained less than 60 wt % in the negative electrode, the reduced amount of the composite material may reduce the capacitance of the electrode. In contrast, if it exceeds 90 wt %, the amount of the conductive material is reduced and thus the conductivity may be deteriorated. Accordingly, it is preferable that the content of the metal oxide/carbon composite material be in the range of 60 to 90 wt %.

The conductive material may include one selected from the group consisting of carbon nanotubes (CNT), ketjen black, acetylene black and a combination thereof. If the content of the conductive material exceeds 30 wt %, the conductivity is improved; however, the amount of the metal oxide/carbon composite material is reduced relatively and thus the capacitance of the electrode may be reduced. Accordingly, it is preferable that the content of the conductive material be in the range of 5 to 30 wt %.

The bonding material may include one selected from the group consisting of polyvinylidene fluoride (PVDF), polytetrafluoroethylene (PTFE) and a combination thereof. In the event that the content of the bonding material exceeds 15 wt %, the bonding force between electrode materials is increased, but electrode resistance may be increased. Accordingly, it is preferable that the content of the bonding material be in the range of 3 to 15 wt %.

The present invention will be described with reference to Example, but the present invention is not limited thereto.

### EXAMPLE

An asymmetric hybrid capacitor in accordance with a preferred embodiment of the present invention was prepared by using LiMn₂O₄ containing lithium as the positive electrode active material and MnO₂ containing no lithium as the negative electrode active material.

First, the positive electrode was formed in such a manner that a slurry was prepared by mixing 65 wt % of LiMn₂O₄ as the active material, 30 wt % of acetylene black as the conductive material, and 5 wt % of polyvinylidene fluoride (PVDF) as the bonding material and thus prepared slurry was applied to titanium foil used as a current collector.

Moreover, the negative electrode was formed in such a manner that a slurry was prepared by mixing 67 wt % of a composite material coated with manganese oxide (MnO₂/CNT) as the active material, 28 wt % of acetylene black as the conductive material, and 5 wt % of polyvinylidene fluoride (PVDF) as the bonding material and thus prepared slurry was applied to titanium foil used as the current collector.

Thus formed positive and negative electrodes were all dried at 100° C. for 12 hours. Then, the asymmetric hybrid capacitor was manufactured using thus formed positive and negative electrodes and an electrolyte composed of 1 M LiClO₄ and a propylene carbonate electrolyte solution.

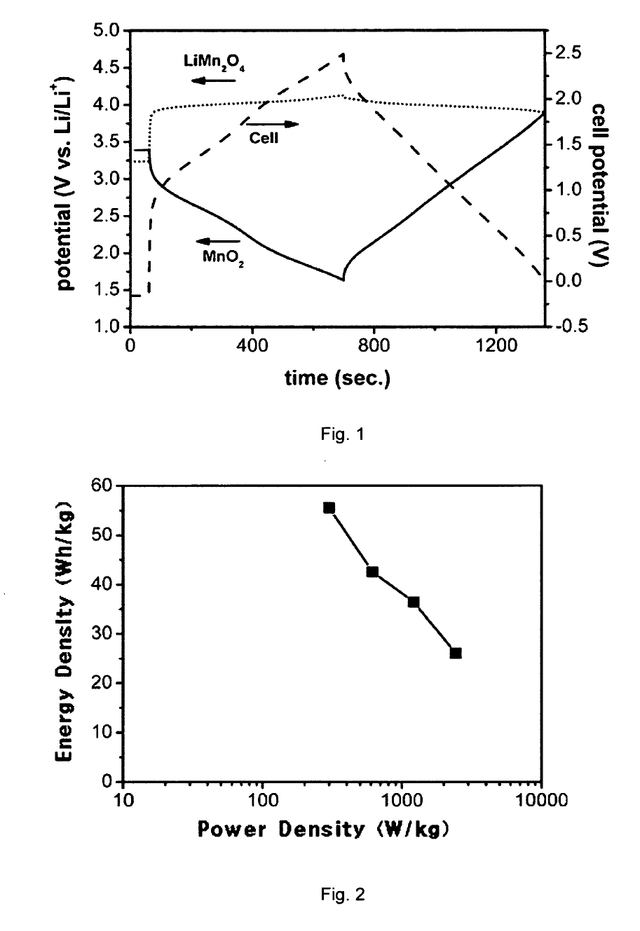

The performance of the asymmetric hybrid capacitor prepared in accordance with this example was evaluated by conducting a charge/discharge test. FIG. 1 is a graph showing first charge/discharge characteristics of the asymmetric hybrid capacitor prepared using the manganese oxide. During charge/discharge, a lithium foil was used as a reference electrode to measure the potential change of the positive and negative electrodes, respectively.

In the asymmetric hybrid capacitor, the initial voltage was −0.2 V, and then the current was applied to charge the capacitor to 2.5 V. As a result, as shown in FIG. 1, the potential of the LiMn₂O₄ positive electrode was increased to 4.1 V, while that of the MnO₂ negative electrode was reduced to 1.6 V.

During the first charge, LiMn₂O₄ and MnO₂ were polarized in the direction of the positive and negative electrodes, and thus they could be used as the positive and negative electrodes, respectively.

At this time, an oxidation reaction occurs in the LiMn₂O₄ positive electrode containing lithium such that lithium ions are discharged from the LiMn₂O₄ structure to the electrolyte, and electrons flow through an external circuit. Moreover, reduction reaction occurs in the MnO₂ negative electrode containing no lithium such that the lithium ions are inserted into the MnO₂ structure and consume the electrons.

During discharge of the capacitor, the reactions proceed in the opposite direction. By the movement of charges and ions, the asymmetrical hybrid capacitor can be charged and discharged.

FIG. 2 is a graph showing energy density vs. power density of the asymmetric hybrid capacitor in accordance with the present invention. When the power density of 300 W/kg, the energy density was 56 Wh/kg, and the energy density was slowly reduced according to an increase in the power density. As a result, the energy density was 26 Wh/kg at a power density of 2400 W/kg.

The energy and power densities of capacitors using manganese oxide and a carbon material, reported in literatures are as follows.

M. S. Hong reported that the asymmetric hybrid capacitor, in which MnO₂ was used as the positive electrode active material and activated carbon was used as the negative electrode active material, had an energy density of 28.8 Wh/kg at an output density of 500 W/kg (Electrochemical and Solid State Letters 5, 2002, A227).

Moreover, Y. G. Wang reported that the asymmetric hybrid capacitor, in which LiMn₂O₄ was used as the positive electrode active material and activated carbon was used as the negative electrode active material, had an energy density of 35 Wh/kg at an output density of 100 W/kg (Electrochemistry Communications 7, 1138, 2005).

Accordingly, it can be understood that the asymmetric hybrid capacitor in accordance with the present invention has excellent energy density characteristics compared with those of the capacitors using the manganese oxide and the carbon material, reported in the recent literature.

As described above, according to the asymmetric hybrid capacitor in accordance with the present invention, since the lithium ions of the same species are used as the positive and negative electrode active materials, it is possible to prevent the ionic species in the electrolyte of the capacitor from being exhausted and minimize reduction in ionic conductivity during charge/discharge. Moreover, since both positive and negative electrode active materials have high specific capacitance, it is possible to maximize energy density and power density.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An asymmetric hybrid capacitor comprising:
a positive electrode active material composed of a metal oxide containing lithium and capable of producing lithium ions by an electrochemical reaction and supplying the lithium ions to an electrolyte in the capacitor; and
a negative electrode active material composed of a metal oxide capable of accepting the lithium ions supplied through the electrolyte,
wherein the lithium ions of the same species move between the positive electrode active material and the negative electrode active material through the electrolyte to achieve charge/discharge.

2. The asymmetric hybrid capacitor of claim 1, wherein the metal oxide of the positive electrode active material is selected from the group consisting of LiMn₂O₄, LiMnO₂, LiCoO₂, LiNiO₂, LiFePO₄, LiCoₓNi_{y}Mn_{z}O₂ (0<x,y,z<1) and a combination thereof.

3. The asymmetric hybrid capacitor of claim 1, wherein the metal oxide of the negative electrode active material is selected from the group consisting of MnO₂, V₂O₅, Ni(OH)₂, NiO, RuO₂, Fe₂O₃, TiO₂, Li₄Ti₅O₁₂, Co(OH)₂, Co₃O₄ and a combination thereof.

4. The asymmetric hybrid capacitor of claim 1, wherein the positive electrode comprises 60 to 90 wt % of the metal oxide, 5 to 30 wt % of a conductive material, and 3 to 15 wt % of a bonding material.

5. The asymmetric hybrid capacitor of claim 1, wherein the negative electrode active material is a metal oxide/carbon composite material in which the metal oxide is coated on the surface of a carbon material, and the negative electrode comprises 60 to 90 wt % of the metal oxide/carbon composite material, 5 to 30 wt % of a conductive material, and 3 to 15 wt % of a bonding material.

6. The asymmetric hybrid capacitor of claim 5, wherein the carbon material is selected from the group consisting of carbon powder, carbon black, acetylene black, ketjen black, activated carbon, carbon nanotubes (CNT), carbon nanofibers (CNF), carbon nanowires (CNW), carbon nanohorns (CNH) and a combination thereof.
